(19) United States
(12) Patent Application Publication
(10) Pub. No.: US 2025/0080669 A1
(43) Pub. Date: Mar. 6, 2025

(54) IMAGE PROCESSING APPARATUS, INFORMATION PROCESSING APPARATUS, SYSTEM, CONTROL METHOD OF IMAGE PROCESSING APPARATUS, INFORMATION PROCESSING APPARATUS, AND SYSTEM, AND STORAGE MEDIUM

(71) Applicant: CANON KABUSHIKI KAISHA, Tokyo (JP)

(72) Inventor: TOMOYA SATO, Kanagawa (JP)

(21) Appl. No.: 18/812,482

(22) Filed: Aug. 22, 2024

(30) Foreign Application Priority Data
Sep. 1, 2023 (JP) 2023-142393

(51) Int. Cl. H04N 1/00; H04N 1/44

(52) U.S. Cl. CPC H04N 1/00493; H04N 1/00244; H04N 1/00973; H04N 1/4433

(57) ABSTRACT

A VNC server in an image forming apparatus provides, for a VNC client in a PC, a URL for calling up, from a Web server, a function of performing an alternative operation of an operation available on an operation screen based on screen information that the VNC server is providing. The VNC client in the PC displays a URL received from the VNC server and notifies a Web browser of the URL in response to an instruction for the URL. The Web browser transmits an HTTP request to the Web server in the image forming apparatus using the URL.

### BACKGROUND

### Field

The present disclosure relates to an image processing apparatus, an information processing apparatus, a system, a control method of the image processing apparatus, the information processing apparatus, and the system, and a storage medium.

### Description of the Related Art

Remotely operating an apparatus is known. An exemplary remote operation function is achieved using software such as the virtual network computing (VNC). VNC server software is started in advance on a server side. On a client side, VNC client software is started, the connection to the server is established, and a remote operation is performed. The communication between the VNC server and the VNC client is performed using the remote frame buffer (RFB) protocol (RFC6143). For example, an apparatus having a VNC server function transmits screen information of an operation screen to a terminal having a VNC client function. On the terminal, the same screen as an operation screen displayed on an operation panel of the apparatus having the VNC server function is displayed. A user can cause the apparatus to perform processing without operating the operation panel of the apparatus by performing an operation on the screen displayed on the terminal.

Japanese Patent Laid-Open No. 2020-191501 discloses a technique for, when abnormality of an operation unit in an image forming apparatus is detected, displaying a screen prompting a VNC access on the operation unit. In the case where the function of remotely operating an apparatus is used, the further improvement of usability is required.

### SUMMARY

The present disclosure has been made to solve the above problem and achieves the further improvement of usability in the case where a function of remotely operating an apparatus is used.

The present disclosure provides an image processing apparatus comprising: at least one memory storing executable instructions; and at least one processor that is configured, upon execution of the stored instructions, to operate as a first server configured to provide a screen information corresponding to an operation screen displayed on an operation unit of the image processing apparatus to an external apparatus connected to the image processing apparatus via a network and receive from, the external apparatus that uses the screen information and is displaying a screen corresponding to the operation screen, operation information corresponding to an operation performed on the screen; and a second server that is configured to provide a function of operating the image processing apparatus from the external apparatus and is different from the first server. The first server provides identification information to the external apparatus which is used for calling up, from the second server, a function that performs an alternative operation which corresponds to an operation available on the operation screen provided by the first server to the external apparatus.

Further features of the present disclosure will become apparent from the following description of exemplary embodiments with reference to the attached drawings.

### BRIEF DESCRIPTION OF THE DRAWINGS

FIG. 1 is a diagram illustrating an example of an information processing system configuration according to an embodiment.

FIG. 2 is a diagram illustrating an exemplary hardware configuration of an image forming apparatus.

FIG. 3 is a diagram illustrating an exemplary software configuration of the image forming apparatus.

FIG. 4 is a diagram illustrating an exemplary hardware configuration of a personal computer (PC).

FIG. 5 is a diagram illustrating an exemplary software configuration of the PC.

FIGS. 6A and 6B are diagrams illustrating examples of a screen displayed on a display/operation unit in the image forming apparatus.

FIG. 7 is a diagram illustrating an example of a screen displayed on a VNC client in the PC.

FIG. 8 is a diagram illustrating an example of a destination data input screen displayed on a Web browser on the PC.

FIG. 9 is a flowchart describing processing of a VNC server in the image forming apparatus according to a first embodiment.

FIG. 10 is a schematic diagram of a display screen-remote user interface (RUI) correspondence table.

FIG. 11 is a flowchart describing the process of a VNC client in the PC according to an embodiment.

FIG. 12 is a diagram illustrating an example of a remote UI top page displayed on a Web browser on the PC.

FIG. 13 is a diagram illustrating an example of a login screen displayed on the display/operation unit in the image forming apparatus.

FIG. 14 is a schematic diagram of a user session information.

FIG. 15 is a flowchart describing the process of a VNC server in an image forming apparatus according to a second embodiment.

### DESCRIPTION OF THE EMBODIMENTS

Embodiments of the present disclosure will be described below with reference to drawings. The embodiments to be described below do not limit the present disclosure according to the claims. All of combinations of features described in the embodiments are not always essential to the means for solution according to the present disclosure. Although the following description will be given using an image forming apparatus as an example of an image processing apparatus, the present disclosure is not limited thereto.

### First Embodiment

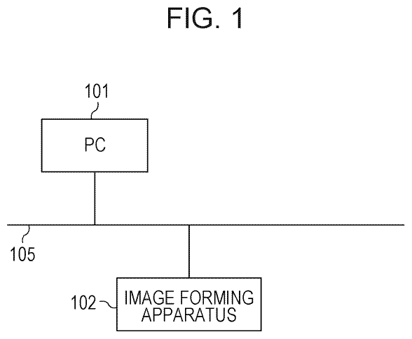

FIG. 1 is a diagram illustrating an example of an information processing system configuration according to an embodiment of the present disclosure.

An image forming apparatus 102 and a personal computer (PC) 101 are communicably connected to a local area network (LAN) 105. In the case where the image forming apparatus 102 and the PC 101 have a radio communication function, the LAN 105 may be formed of a wireless LAN or be formed of a wired LAN and a wireless LAN. The image forming apparatus 102 has a virtual network computing (VNC) server function and a Web server function. The PC 101 is an information processing apparatus having a VNC client function and a Web browser function.

In the present embodiment, the case will be described in which the PC 101 having the VNC client function and the Web browser function is connected to the image forming apparatus 102 having the VNC server function and the Web server function. However, a connection target client may be any apparatus (e.g., a mobile terminal or another image forming apparatus) having the VNC client function and the Web browser function.

The image forming apparatus 102 operating as a VNC server and the Web server function will be hereinafter referred to as a “server”. An information processing apparatus such as the PC 101 connected to this server will be hereinafter referred to as a “client”.

First, a remote operation function will be described.

The image forming apparatus 102 having the VNC server function transmits screen information corresponding to a screen displayed on a display unit thereof to a client. The client that has received the screen information displays the same screen as the screen displayed on the image forming apparatus 102 based on the received screen information. In the case where an operation is performed on the screen displayed on the client, information about the operation is transmitted to the image forming apparatus 102 and the image forming apparatus 102 performs processing in response to the operation. That is, the client can perform a remote operation upon the image forming apparatus 102 by establishing a VNC connection to the image forming apparatus 102.

First, the image forming apparatus 102 starts VNC server software. The image forming apparatus 102 waits for a connection request from the client. The PC 101 starts VNC client software. The PC 101 connects to the image forming apparatus 102 in response to, for example, a user operation. The communication between the server and the client is performed in accordance with the remote frame buffer (RFB) protocol. The RFB protocol performs handshake processing first and performs the transmission and reception of screen information and operation information after the completion of the handshake processing.

Next, a remote UI function will be described.

The technique is widely known for enabling hypertext transfer protocol (HTTP) communication between an image forming apparatus having the Web server function and a Web browser operating on the client side. The checking of the state of such an image forming apparatus (e.g., information about whether the image forming apparatus is in operation or the status of a job) and various pieces of setting information and an operation of changing various setting values can be performed using the Web browser on the client side. This function is called the remote UI function.

In response to a request from the Web browser on the client, the image forming apparatus 102 having the Web server function performs processing based on a requested URL and transmits Web page data written in, for example, the HTML or a scripting language to the client. The Web browser on the client forms a screen based on the Web page data received from the server and displays the screen.

At that time, the communication between the image forming apparatus 102 and the Web browser on the client is performed in accordance with the HTTP. The checking of the state of the image forming apparatus 102 (e.g., information about whether the image forming apparatus 102 is in operation or the status of a job) and various pieces of setting information and an operation of changing various setting values can be performed using the Web browser on the client side.

Since the same screen as a screen displayed on an operation panel of the image forming apparatus is displayed on the client with the above remote operation function, the same operability as operability obtained on the operation panel of the image forming apparatus can be provided for a user on the client side. In this respect, the remote operation function may be more user-friendly than the remote UI function.

However, in some cases, an operation is more easily performed with the remote UI function than with the remote operation function. For example, that is the case where character strings are input on various setting screens of an image forming apparatus. In the case where a character string is input with the remote operation function, a soft keyboard screen displayed on a screen of an image forming apparatus is displayed on the client side and an input operation is performed on the screen. However, an input operation is more difficult to perform upon a soft keyboard than upon a traditional hard keyboard.

On the other hand, in the case where a character string is input with the remote UI function, an input operation can be easily performed with a hard keyboard of a client PC that is normally used to type characters strings on the client PC. The input operation can also be performed by a copy and paste operation performed via, for example, another piece of software operating on the client PC. An operation screen of a PC on the client side is generally larger than an operation screen of an image forming apparatus. Accordingly, the number of jobs that can be displayed on a single screen such as a job history display screen with the remote UI function is larger. This increases the degree of browsability and may lead to an easier operation.

Thus, in some cases, an operation is more easily performed with another remote operation function, such as the remote UI function than with the remote UI function.

However, in apparatuses in the related art, there is no mechanism for appropriately directing a user who is using the remote operation function to another remote operation function (e.g., the remote UI function) from an external apparatus.

In the present embodiment, there is provided a mechanism for appropriately directing a user who is using the remote operation function from an external apparatus to another remote operation function (e.g., the remote UI function) with which an operation equivalent to an operation performed on a screen displayed with the remote operation function can be performed. As a result, a user who is using the remote operation function can be appropriately directed from an external apparatus to another remote operation function with which an operation equivalent to an operation performed on a screen displayed with the remote operation function can be performed. This can improve the convenience of users.

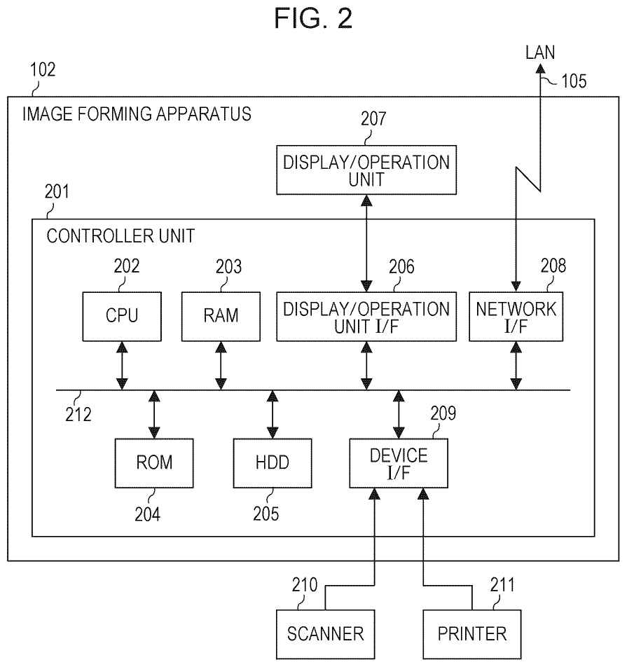

FIG. 2 is a diagram illustrating an exemplary hardware configuration of the image forming apparatus 102.

In a controller unit 201 in the image forming apparatus 102, a CPU 202 is a computing device for controlling the entire system. The CPU 202 performs overall control of respective devices connected to a system bus 212.

A read-only memory (ROM) 204 is a non-volatile memory and stores image data, another piece of data, and various programs for the operation of the CPU 202. A RAM 203 is a volatile memory and is used as a temporary storage area such as a main memory or a work area for the CPU 202 The RAM 203 also stores programs such as an operating system (OS), system software, application software, and data.

The CPU 202 controls each unit in the image forming apparatus 102 by deploying a program stored in, for example, the ROM 204 into the RAM 203 and executing the program. The program for the CPU 202 to operate is not limited to the program stored in the ROM 204, and a program stored in advance in, for example, a hard disk drive (HDD) 205 may be used.

The HDD 205 stores, for example, an OS, system software, application software, image data, and setting data. Another storage apparatus such as a solid state drive (SSD), an SD memory card, or an embedded multimedia card (eMMC) may be used instead of or in combination with the HDD on condition that the storage apparatus can store similar data.

A display/operation unit I/F 206 is an interface unit with a display/operation unit 207, and outputs information to be displayed on the display/operation unit 207 to the display/operation unit 207. The display/operation unit I/F 206 receives information input by a user from the display/operation unit 207. The display/operation unit 207 includes hard keys and a touch panel for receiving a user operation.

A network I/F 208 connects to a network (LAN) 105 and communicates with, for example, the PC 101 connected to the same LAN.

A device I/F 209 connects a scanner 210 and a printer 211, which are image input/output devices, to the controller unit 201 and performs the input and output of image data. That is, the device I/F 209 performs the input and output of data at the time of, for example, the printing of image data on a sheet and the scanning of a document.

The image forming apparatus 102 having, for example, a copy function, a print function, and a scan function is used as an image processing apparatus according to the present embodiment, but the present embodiment is not limited thereto. For example, an apparatus having only the scan function or the print function or having another function such as a facsimile function may be used.

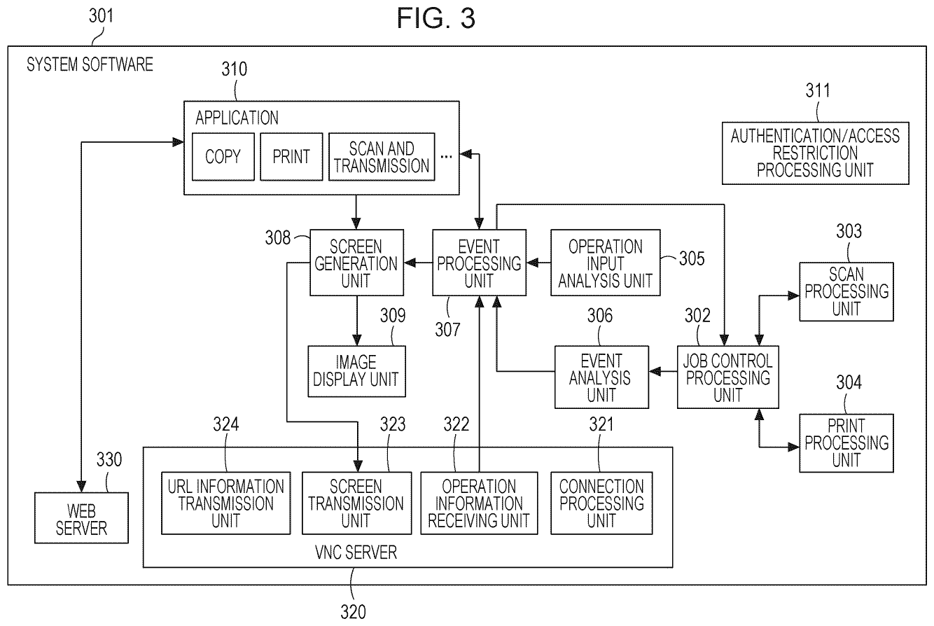

FIG. 3 is a diagram illustrating an exemplary software configuration of the image forming apparatus 102.

Each function of system software 301 illustrated in FIG. 3 is performed by the CPU 202 executing a program (computer executable instructions) stored in any one of the RAM 203, the ROM 204, and the HDD 205.

A job control processing unit 302 controls respective software modules including an application 310 and controls jobs such as copy, print, scan executed by the image forming apparatus 102.

A scan processing unit 303 controls the scanner 210 via the device I/F 209 in response to an instruction from the job control processing unit 302 to perform processing for reading a document placed on a platen glass of the scanner 210.

A print processing unit 304 controls the printer 211 via the device I/F 209 in response to an instruction from the job control processing unit 302 to perform processing for printing a designated image.

An operation input analysis unit 305 analyzes information supplied from the display/operation unit 207 via the display/operation unit I/F 206 and notifies an event processing unit 307 of an event corresponding to a user operation. The information analyzed by the operation input analysis unit 305 is operation information indicating that a user has pressed a hard key or a touch panel.

An event analysis unit 306 receives various phenomena other than the operation input which occur in the image forming apparatus 102 from, for example, the job control processing unit 302, analyzes each of the phenomena, and notifies the event processing unit 307 of an event corresponding to the phenomenon. The various phenomena analyzed by the event analysis unit 306 are phenomena other than the phenomenon that occurs in response to the operation of a user, such as a job completion or a shortage of print sheets.

The event processing unit 307 receives an event from, for example, the operation input analysis unit 305, the event analysis unit 306, an operation information receiving unit 322, or the application 310. The event processing unit 307 notifies the job control processing unit 302, a screen generation unit 308, or the application 310 of the event based on the event and controls the corresponding units in the image forming apparatus 102.

The screen generation unit 308 performs processing for generating, in the RAM 203, data of a screen to be displayed on the display/operation unit 207 or a display unit of an external apparatus. The screen generation unit 308 stores an ID used to uniquely identify a generated screen.

An image display unit 309 reads the screen data generated by the screen generation unit 308 from the RAM 203 and performs display control for displaying the screen data on a display of the display/operation unit 207 via the display/operation unit I/F 206.

The application 310 is the group of applications operating on the image forming apparatus 102, receives an instruction from a user via the event processing unit 307 or a Web server 330, and performs predetermined processing such as processing for notifying the event processing unit 307 of an event for the control of a job in response to the instruction. For example, the applications that the image forming apparatus 102 has are as follows.
An application corresponding to a “copy” function of causing the scanner 210 to read an image of a physical document to generate image data and causing the printer 211 to print the image data
An application corresponding to a “print” function of causing the printer 211 to print image data based on a print job transmitted from an external apparatus such as the PC 101
An application corresponding to a “scan and transmission” function causes the scanner 210 to read an image of a document to generate image data and externally transmit the image data via the network I/F 208.

The applications that the image forming apparatus 102 has are not limited to the above applications, and another application may be added in response to an instruction from a user.

An authentication/access restriction processing unit 311 performs user authentication processing and access restriction processing for each authenticated user.

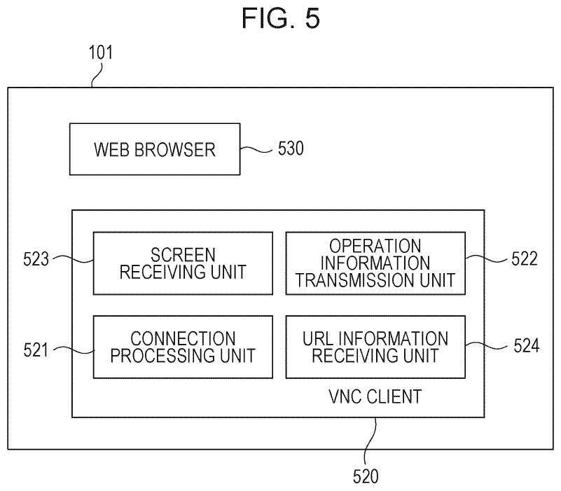

A VNC server 320 is a software module for performing VNC communication with a client via the LAN 105. For example, the VNC server 320 communicates with a VNC client 520 (FIG. 5) operating on the PC 101 and performs processing for receiving a remote operation.

In the VNC server 320, a connection processing unit 321 receives a connection request from, for example, a connection processing unit 521 (FIG. 5) in the VNC client 520 and performs connection control.

The operation information receiving unit 322 receives operation information from, for example, an operation information transmission unit 522 (FIG. 5) in the VNC client 520 and notifies the event processing unit 307 of an event corresponding to a user operation.

A screen transmission unit 323 performs processing for reading screen data generated by the screen generation unit 308 from the RAM 203 and transmits the image data to a screen receiving unit 523 (FIG. 5) in the VNC client 520.

The VNC server 320 according to the present embodiment further includes a URL information transmission unit 324. The URL information transmission unit 324 transmits to a URL information receiving unit 524 (FIG. 5) in the VNC client 520 a URL for performing (calling up), with the remote UI function, an operation equivalent to an operation that can be performed on a screen that is generated by the screen generation unit 308 and is displayed on the image display unit 309. The URL information transmission unit 324 will be described in detail below.

The Web server 330 is a software module for performing HTTP communication with a client via the LAN 105. For example, the Web server 330 communicates with a Web browser 530 (FIG. 5) operating on the PC 101 and performs processing for providing the remote UI function for the Web browser 530. Specifically, the Web server 330 receives an HTTP request from the Web browser 530, analyzes the HTTP request, controls the application 310 based on the request, and responds with Web page data as an HTTP response.

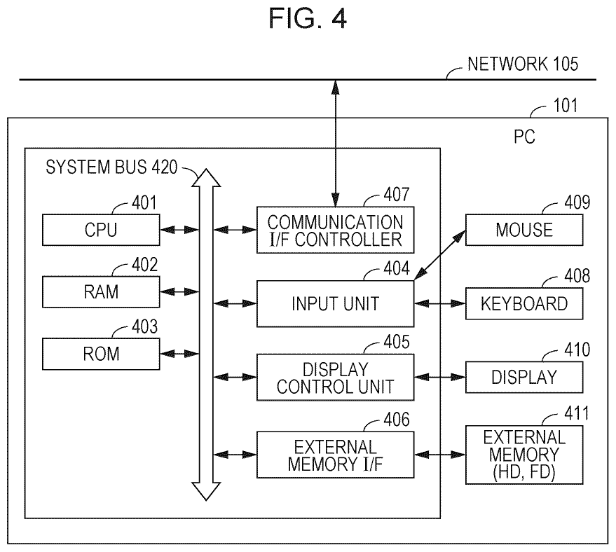

FIG. 4 is a diagram illustrating an exemplary hardware configuration of the PC 101.

A CPU 401, a ROM 402, a RAM 403, an input unit 404, a display control unit 405, an external memory I/F 406, and a communication I/F controller 407 are connected to a system bus 420. A keyboard 408 and a mouse 409 are connected via the input unit 404, a display 410 is connected via the display control unit 405, and an external memory 411 is connected via the external memory I/F 406. Respective units connected to the system bus 420 are configured to exchange data with each other via the system bus 420.

The ROM 402 is a non-volatile memory and stores image data, another piece of data, and various programs for the operation of the CPU 401 in respective regions.

The RAM 403 is a volatile memory and is used as a temporary storage area such as a main memory and a work area for the CPU 401.

The CPU 401 controls each unit in the PC 101 in accordance with, for example, a program stored in the ROM 402 while using the RAM 403 as a work memory. The program for the CPU 401 to operate is not limited to the program stored in the ROM 402, and may be stored in advance in, for example, the external memory (e.g., a hard disk) 411.

The input unit 404 receives a user operation, generates a control signal corresponding to the operation, and supplies the control signal to the CPU 401. The keyboard 408 and the mouse 409 are connected to the input unit 404 as input devices for receiving a user operation. Based on a control signal that the input unit 404 has generated in response to a user operation performed upon the input device and supplied to the CPU 401, the CPU 401 controls each unit in the PC 101 in accordance with a program. The PC 101 can be caused to perform an operation corresponding to the user operation.

The display control unit 405 outputs a display signal for displaying an image on the display 410. For example, a display control signal that the CPU 401 has generated in accordance with a program is supplied to the display control unit 405. The display control unit 405 generates a display signal based on this display control signal and outputs the display signal to the display 410. For example, the display control unit 405 displays a GUI (graphical user interface) screen forming a GUI on the display 410 based on the display control signal generated by the CPU 401.

The external memory 411 such as an HDD, an SSD, a flexible disk, a CD, a DVD, or a memory card can be attached to the external memory I/F 406. Under the control of the CPU 401, the reading of data from the attached external memory 411 or the writing of data in the attached external memory 411 is performed.

Under the control of the CPU 401, the communication I/F controller 407 communicates with, for example, various networks 105 such as a LAN and the Internet in a wired and wireless manners.

FIG. 5 is a diagram illustrating an exemplary software configuration of the PC 101.

The function of each software module illustrated in FIG. 5 is obtained by the CPU 401 executing a program stored in any one of the RAM 403, the ROM 402, and the external memory 411.

The VNC client 520 is a software module for remotely operating the image forming apparatus 102 by communicating with the VNC server 320 operating on the image forming apparatus 102 via the LAN 105.

In the VNC client 520, the connection processing unit 521 transmits a connection request to the connection processing unit 321 in the VNC server 320 upon receiving a request from a user and preforms connection processing.

The operation information transmission unit 522 transmits an operation instruction that a user has input via the keyboard 408 and the mouse 409 to the operation information receiving unit 322 in the VNC server 320.

The screen receiving unit 523 receives screen data from the screen transmission unit 323 in the VNC server 320 and displays a screen on the display 410 via the display control unit 405.

By the above processing of each software module, the same screen as a screen displayed on the display of the display/operation unit 207 in the image forming apparatus 102 is also displayed on the display 410 of the PC 101. When a user operates the screen from the PC 101, the image forming apparatus 102 can be remotely caused to perform various pieces of processing (the remote operation function).

The VNC client 520 according to the present embodiment further includes the URL information receiving unit 524.

The URL information receiving unit 524 receives URL information transmitted from the URL information transmission unit 324 in the VNC server 320 and displays the received URL on the display 410 of the PC 101. The processing of the URL information receiving unit 524 will be described in detail below.

The Web browser 530 is a widely known Web browser application and can perform HTTP communication with a Web server. The Web browser 530 communicates with the Web server 330 operating on the image forming apparatus 102 and displays respective screens provided with the remote UI function of the image forming apparatus 102.

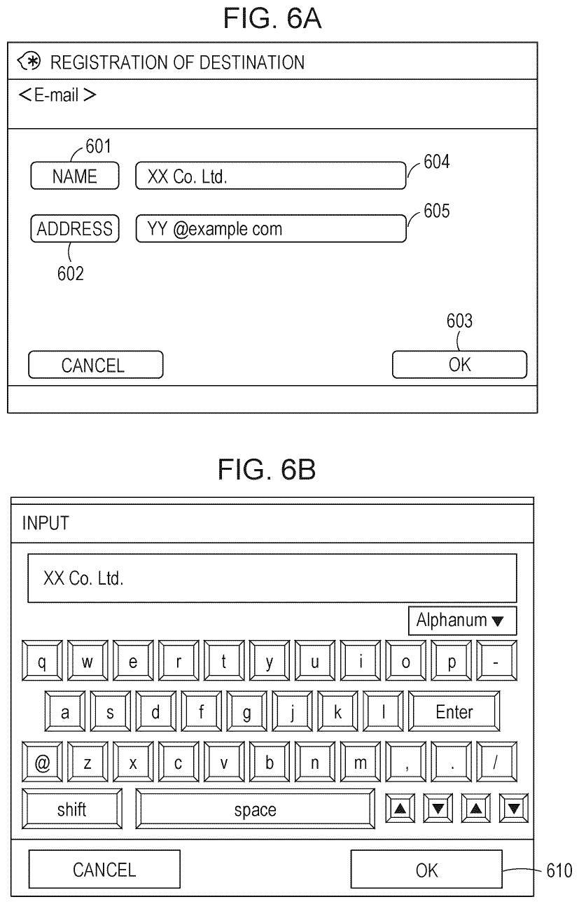

FIGS. 6A and 6B are diagrams illustrating examples of a screen displayed on the display/operation unit 207 in the image forming apparatus 102. A screen on which destination data of a destination table stored in the image forming apparatus 102 is input will be described as an example.

FIG. 6A is a diagram illustrating a screen called up when destination data of a destination table stored in the image forming apparatus 102 is input. A button 601 is a name input button. When this button is operated, a soft keyboard screen illustrated in FIG. 6B is called up. A user inputs the name of a destination using the displayed soft keyboard and presses down an OK button 610. When the OK button 610 is operated, the screen returns to the screen illustrated in FIG. 6A. At that time, the above name input with the soft keyboard is set in a name input region 604.

A button 602 is an address input button. When this button is operated, the soft keyboard screen illustrated in FIG. 6B is called up like the case where the name input button 601 is operated. The user inputs an address using the displayed soft keyboard and presses down the OK button 610. When the screen returns to the screen illustrated in FIG. 6A, the above address input with the soft keyboard is set in an address input region 605.

The user sets the name and the address and presses down an OK button 603. When the OK button 603 is operated, destination data corresponding to the input setting is generated and is stored in the image forming apparatus 102.

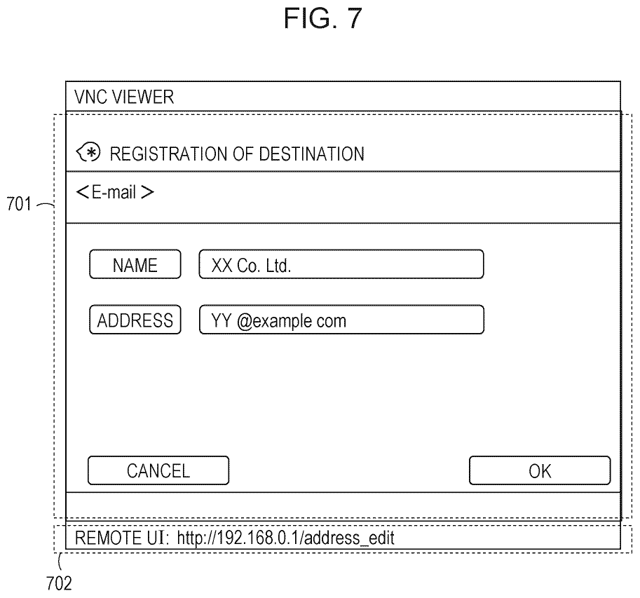

FIG. 7 is a diagram illustrating an example of a screen displayed on the screen of the PC 101 when the VNC client 520 in the PC 101 is operated and is connected to the image forming apparatus 102 in the state where the screen illustrated in FIG. 6A is displayed on the image forming apparatus 102.

A region 701 is a received screen data display region. Screen data received by the screen receiving unit 523, that is, the same screen as the screen (FIG. 6A) displayed on the display/operation unit 207 in the image forming apparatus 102, is displayed in the region 701. A user can perform an operation equivalent to an operation performed on each screen illustrated in FIGS. 6A and 6B by operating respective buttons on the screen displayed in the region 701. That is, when the name input button or the address input button is operated, for example, the soft keyboard screen illustrated in FIG. 6B is called up. A user can perform the input of a destination name or an address with the displayed soft keyboard.

A region 702 is a URL information display region. A URL that the URL information receiving unit 524 has been notified by the URL information transmission unit 324 in the image forming apparatus 102 is displayed in the URL information display region 702. In this example, a URL for performing an operation of inputting destination data with the remote UI function is displayed in the URL information display region 702.

When a user presses down the URL information display region 702, the VNC client 520 notifies the Web browser 530 of the URL information displayed in the URL information display region 702.

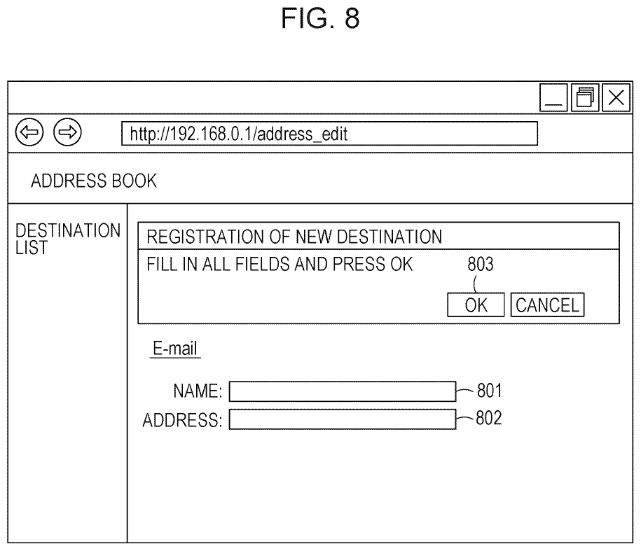

The Web browser 530 transmits an HTTP request to the notified URL. The Web server 330 in the image forming apparatus 102 that has received the HTTP request transmits data of a corresponding Web page to the Web browser 530 as an HTTP response. The Web browser 530 displays a screen (e.g., a screen illustrated in FIG. 8) in accordance with the response.

FIG. 8 is a diagram illustrating an example of a screen displayed on the Web browser 530 when a URL for the performance of an operation of inputting destination data is specified.

A region 801 is a name input region, and a region 802 is an address input region. A user performs an input operation in the respective regions with the keyboard 408 and the mouse 409 and presses down an OK button 803. By this operation, an HTTP request is transmitted from the Web browser 530 to the Web server 330, and a destination corresponding to settings input in the respective regions can be generated and stored in the image forming apparatus 102. That is, an operation equivalent to an operation performed on the screen (e.g., the screen illustrated in FIG. 7) displayed in the region 701 of the VNC client 520 can be performed with the remote UI function. The input operation performed in the name input region 801 and the address input region 802 can also be performed by a copy and paste operation performed via, for example, another piece of software operating on the PC 101.

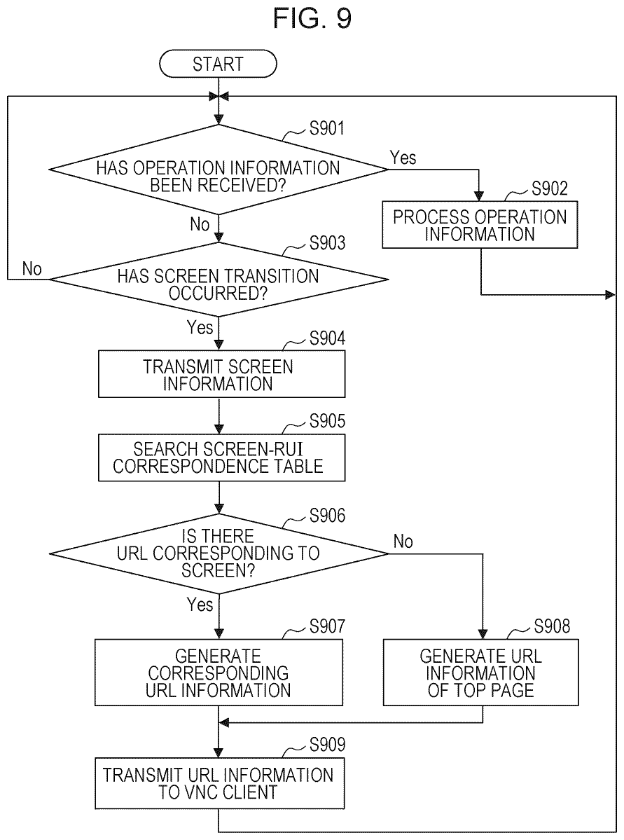

FIG. 9 is a flowchart describing the process of the VNC server 320 in the image forming apparatus 102 according to the first embodiment. Each piece of processing in this flowchart is performed by the CPU 202 reading out a program for implementing a corresponding control module stored in the ROM 204 or the HDD 205 into the RAM 203 executing the program.

First, in S901, the CPU 202 determines whether operation information has been received. The received operation information is an operation instruction input by a user via the keyboard 408 and the mouse 409 in the PC 101 has been transmitted from the operation information transmission unit 522 to the operation information receiving unit 322 in the VNC server 320.

Upon receiving the operation information (Yes in S901), the CPU 202 proceeds to the processing of S902. In S902, the CPU 202 processes the operation information received in S901. Specifically, the operation information received by the operation information receiving unit 322 is notified to the event processing unit 307, and the event processing unit 307 controls each unit in the image forming apparatus 102 based on the operation information. Subsequently, the CPU 202 returns the process to S901.

On the other hand, when the operation information is not received (No in S901), the CPU 202 proceeds to the processing of S903. In S903, the CPU 202 determines whether a screen transition has occurred. The screen transition may occur, for example, in the case where the operation input analysis unit 305 has received the input of a user operation or in the case where the event processing unit 307 has received an event corresponding to the status of a job processed by the job control processing unit 302.

When the screen transition does not occur (No in S903), the CPU 202 returns the process to S901.

On the other hand, when the screen transition has occurred (Yes in S903), the CPU 202 proceeds to the processing of S904. In S904, the CPU 202 transmits screen information to the VNC client 520. Specifically, the screen transmission unit 323 performs processing for reading screen data generated by the screen generation unit 308 from the RAM 203 and transmitting the screen data to the screen receiving unit 523 in the VNC client 520.

Subsequently, in S905, the CPU 202 searches a “display screen-remote user interface (RUI) correspondence table”. The “display screen-RUI correspondence table” is stored in the ROM 204 or the HDD 205 in the image forming apparatus 102 in advance. The “display screen-RUI correspondence table” will be described.

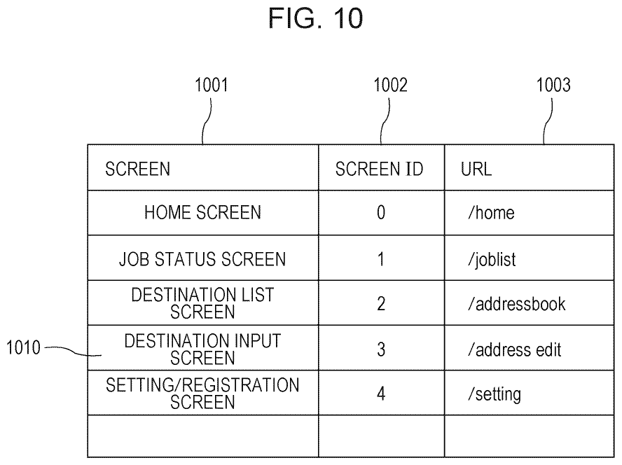

FIG. 10 is a schematic diagram of the display screen-RUI correspondence table.

A column 1001 represents a display screen, a column 1002 represents an ID used to uniquely identify the display screen, and a column 1003 represents a path (URL) for, with the remote UI function, performing (calling up) an operation (alternative operation) equivalent to an operation that can be performed on the display screen.

For example, a row 1010 indicates that a remote UI path for, with the remote UI function, performing an operation equivalent to an operation that can be performed on a destination data input screen is “/address_edit”.

The description will refer back to the flowchart illustrated in FIG. 9. In S905 described above, the CPU 202 determines whether the column 1002 of the display screen-RUI correspondence table includes the ID of a currently displayed screen.

Subsequently, in S906, the CPU 202 determines whether a corresponding remote UI path (URL) (i.e., a remote UI path that matches the ID of the currently displayed screen) has been found as a result of S905 described above. When the path has been found (Yes in S906), the CPU 202 proceeds to the processing of S907.

In S907, the CPU 202 generates corresponding URL information. Specifically, the URL information is generated by coupling the IP address of the apparatus which is stored by the network I/F 208 and the path found in the “display screen-RUI correspondence table”. For example, when the IP address of the apparatus is “192.168.0.1” and the displayed screen is, for example, the address edit screen (the screen ID=3) illustrated in FIG. 7, the URL information of “http://192.168.0.1/address_edit” is generated. When this URL is requested by the Web browser, the Web server 330 transmits Web page data used for the display of, for example, the screen illustrated in FIG. 8 as a response.

On the other hand, when the corresponding path is not present (No in S906), the CPU 202 proceeds to the processing of S908.

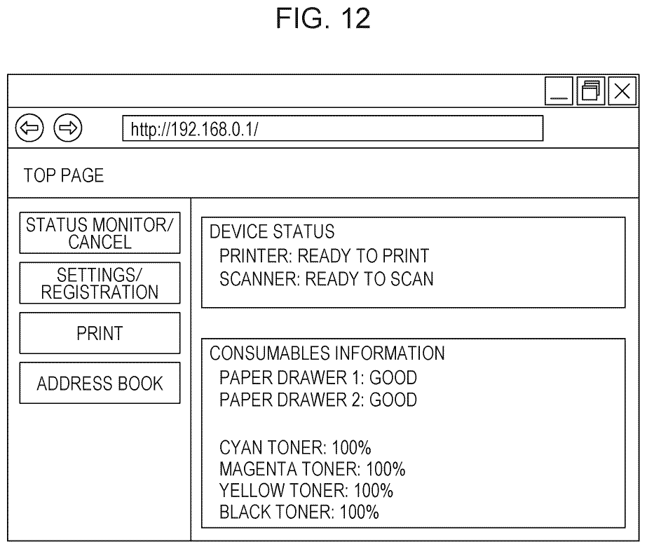

In S908, the CPU 202 generates URL information of a remote UI top page. For example, when the IP address of the apparatus is “192.168.0.1”, the URL information of “http://192.168.0.1/” is generated. When this URL is requested by the Web browser, the Web server 330 transmits Web page data used for the display of, for example, a remote UI top page illustrated in FIG. 12 as a response.

FIG. 12 is a diagram illustrating an example of a remote UI top page.

After the processing of S907 or S908 described above, the CPU 202 proceeds to the processing of S909.

In S909, the CPU 202 transmits the URL information generated in S907 or S908 described above to the VNC client being connected thereto. The transmission of the URL information may be performed by notifying the URL information as, for example, ServerCutText data determined by the RFB protocol or uniquely extended data not determined by the RFB protocol.

After the processing of S909, the CPU 202 returns the process to S901.

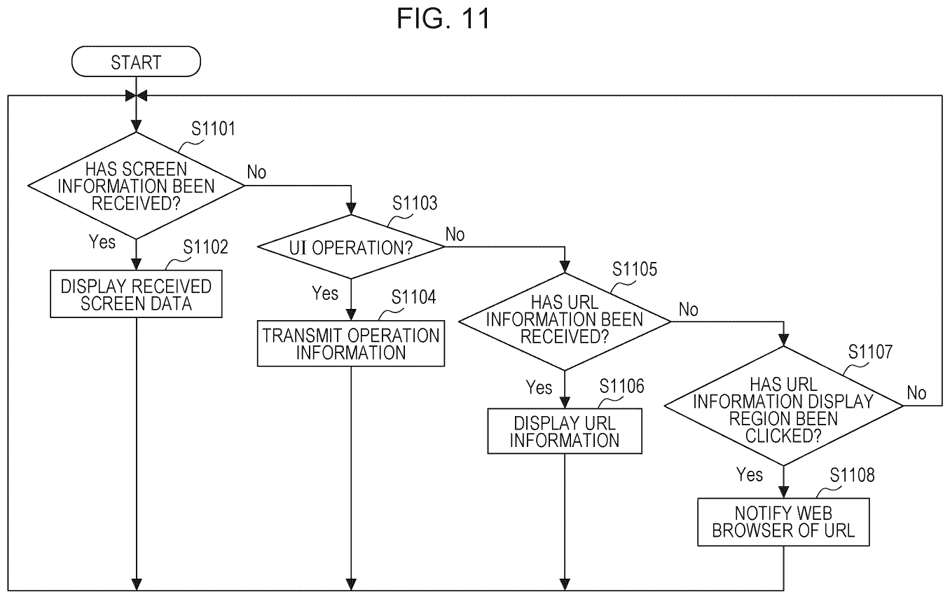

FIG. 11 is a flowchart describing the process of the VNC client 520 in the PC 101 according to the present embodiment. Each piece of processing in this flowchart is performed by the CPU 401 reading out a program for implementing a corresponding control module stored in the ROM 402 or the external memory 411 into the RAM 403 and executing the program.

First, in S1101, the CPU 401 determines whether screen information has been received. Specifically, it is determined whether the screen receiving unit 523 has received screen data from the screen transmission unit 323 in the VNC server 320.

When determining that screen information has been received (Yes in S1101), the CPU 401 proceeds to the processing of S1102.

In S1102, the CPU 401 displays the received screen data. Specifically, the CPU 401 displays the screen data received by the screen receiving unit 523 (that is, the same screen as a screen displayed on the display/operation unit 207 in the image forming apparatus 102) in the received screen data display region 701. After the processing of S1102, the CPU 401 returns the process to S1101.

When screen information is not received (No in S1101), the CPU 401 proceeds to the processing of S1103.

In S1103, the CPU 401 determines whether a UI operation has been performed. Specifically, it is determined whether a user has operated the screen displayed in the received screen data display region 701 by operating the keyboard 408 and the mouse 409.

When determining that a UI operation has been performed (Yes in S1103), the CPU 401 proceeds to the processing of S1104.

In S1104, the CPU 401 transmits operation information. Specifically, the operation information transmission unit 522 transmits information about an operated key or clicked coordinates to the operation information receiving unit 322 in the VNC server 320 as KeyEvent or PointerEvent in the RFB protocol. After the processing of S1104, the CPU 401 returns the process to S1101.

When determining that a UI operation has not been performed (No in S1103), the CPU 401 proceeds to the processing of $1105.

In S1105, the CPU 401 determines whether URL information has been received. Specifically, it is determined whether the URL information receiving unit 524 has received URL information from the URL information transmission unit 324 in the VNC server 320.

Upon receiving the URL information (Yes in S1105), the CPU 401 proceeds to the processing of S1106.

In S1106, the CPU 401 displays the URL information received in S1105 described above. Specifically, the received URL information is displayed in the URL information display region 702 as link information. After the processing of S1106, the CPU 401 returns the process to S1101.

When determining that URL information has not been received (No in S1105), the CPU 401 proceeds to the processing of S1107.

In S1107, the CPU 401 determines whether the URL information display region 702 has been subjected to a click operation. Specifically, it is determined whether coordinates operated by the mouse 409 are coordinates in the URL information display region 702.

When determining that the URL information display region 702 has been clicked (Yes in S1107), the CPU 401 proceeds to the processing of S1108.

In S1108, the CPU 401 notifies the Web browser 530 of a URL displayed in the URL information display region 702 and returns the process to S1101.

The Web browser 530 transmits an HTTP request to the notified URL and displays a screen based on a response. For example, when the destination input screen illustrated in FIG. 7 is displayed, a notified URL is “http://192.168.0.1/address_edit”. When the Web browser 530 transmits an HTTP request to the notified URL of “http://192.168.0.1/address_edit”, the screen illustrated in FIG. 8 is displayed on the Web browser 530.

When determining that the URL information display region 702 has not been clicked (No in S1107), the CPU 401 returns the process to S1101.

By the processes of the flowcharts illustrated in FIGS. 9 and 11, the image forming apparatus 102 can appropriately direct a user who is using the remote operation function to the remote UI function with which an operation equivalent to an operation performed on a screen displayed with the remote operation function can be performed. As a result, the user can easily perform an operation equivalent to an operation performed on a screen displayed on the VNC client 520 with the remote UI function. This can improve usability at the time of the remote operation of the image forming apparatus 102.

### Second Embodiment

In a second embodiment, when a user logs in the image forming apparatus 102, control is performed such that the same user performs a login with the remote UI function.

In the second embodiment, the image forming apparatus 102 is subjected to a user authentication operation. When a user uses the image forming apparatus 102, the user is required to perform a login operation. The image forming apparatus 102 determines whether a legitimate user has performed a login and performs control such that only processing authorized for the user can be performed. The same applies to the case where the remote UI function is used.

That is, when the URL of the remote UI function of the image forming apparatus 102 is accessed with a Web browser, the image forming apparatus 102 transmits Web page data of a login screen for a login operation to a client. A user inputs, for example, a user name and a password into the login screen displayed on the Web browser. The image forming apparatus 102 determines whether a legitimate user has performed a login and controls the remote UI function such that only processing authorized for the user can be performed.

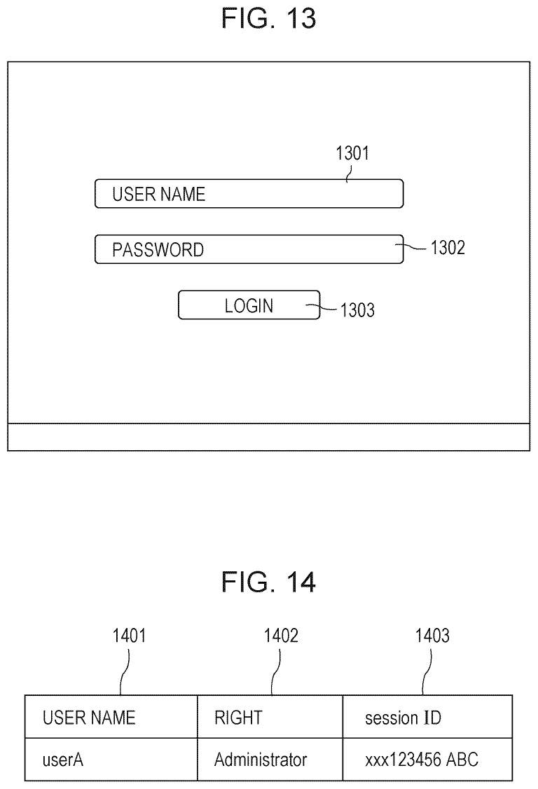

FIG. 13 is a diagram illustrating an example of a login screen displayed on the display/operation unit 207 in the image forming apparatus 102.

In the case where the image forming apparatus 102 is subjected to a user authentication operation, the image forming apparatus 102 displays the login screen illustrated in FIG. 13 when being started.

A region 1301 is a name input region, and a region 1302 is a password input region. When each region is operated, the image forming apparatus 102 calls up, for example, the soft keyboard screen illustrated in FIG. 6B. A user inputs a user name and a password with the displayed soft keyboard. When a login button 1303 is operated, the image forming apparatus 102 performs authentication processing.

The authentication processing may be performed with a user database stored in the image forming apparatus 102 in advance or by an authentication server (not illustrated) disposed on, for example, the LAN 105. The input of a user name and a password by a user does not necessarily have to be performed, and the use of, for example, an IC card or the use of biometric authentication may be performed.

When a use performs a login, the image forming apparatus 102 stores login session information in the image forming apparatus 102 (e.g., in the RAM 203).

FIG. 14 is a schematic diagram of login session information that is stored and managed in the image forming apparatus 102.

In the login session information, a user name 1401 of a user who has performed a login, a right 1402 of the user who has performed the login, and a session ID 1403 used to uniquely identify a session are associated with each other. The session ID is generated at the time of login processing and a random character string.

When the user performs a logout, the image forming apparatus 102 destroys the login session information illustrated in FIG. 14.

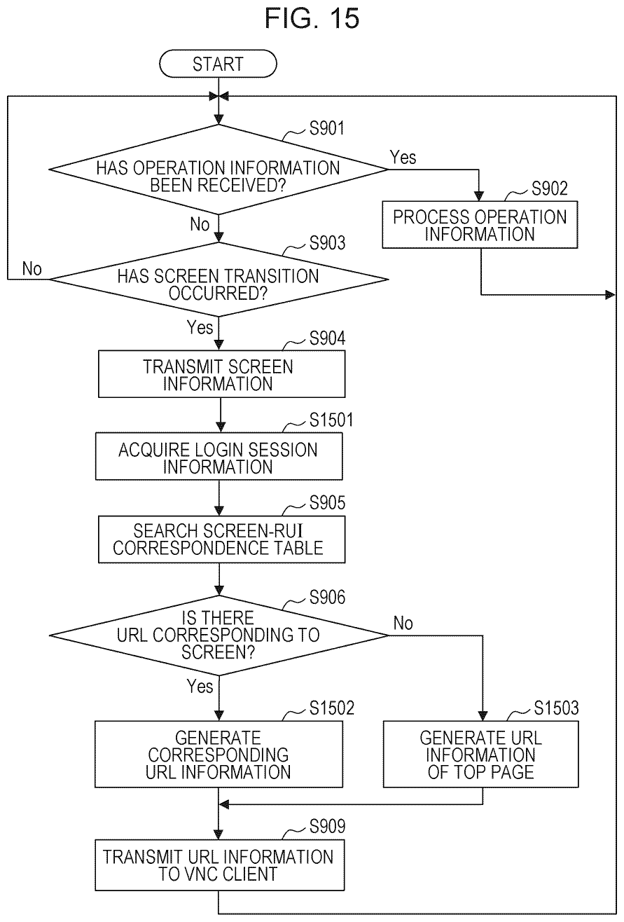

FIG. 15 is a flowchart describing the process of the VNC server 320 in the image forming apparatus 102 according to the second embodiment. Each piece of processing in this flowchart is performed by the CPU 202 reading out a program for implementing a corresponding control module stored in the ROM 204 or the HDD 205 into the RAM 203 and executing the program. The steps in the flowchart illustrated in FIG. 15 same as the steps in the flowchart illustrated in FIG. 9 described in the first embodiment are each given the same step number. Only differences therebetween will be described below.

The process to S904 is the same as that illustrated in FIG. 9. After S904, the CPU 202 acquires login session information in S1501. Specifically, the CPU 202 reads out the information illustrated in FIG. 14 which has been stored in the image forming apparatus 102 at the time of login processing. After S1501, the pieces of processing of S905 and S906 are the same as those illustrated in FIG. 9.

In the case of Yes in S906, the CPU 202 proceeds to the processing of S1502. On the other hand, in the case of No in S906, the CPU 202 proceeds to the processing of S1503.

The pieces of processing of S1502 and S1503 are similar to the pieces of processing of S907 and S908, respectively.

However, the difference between the pieces of processing of S1502 and S1503 and the pieces of processing of S907 and S908 is that the login session information acquired in S1501 is added to URL information to be generated.

For example, when a user A is logging in and the session information illustrated in FIG. 14 is stored, the URL information generated in S1502 is “http://192.168.0.1/address_edit?sessionID=xxx123456ABC”. The URL information generated in S1503 is “http://192.168.0.1/?sessionID=xxx123456ABC”.

The processing of S909 is the same as that illustrated in FIG. 9.

The pieces of processing of the VNC client 520 and the Web browser 530 are the same as those described in the first embodiment. Accordingly, a URL that the Web browser 530 is notified by the VNC client 520 includes the above login session information that has been added. The Web browser 530 transmits an HTTP request to the URL to which the login session information has been added. Upon receiving the HTTP request, the Web server 330 checks the login session information (FIG. 14) stored in the image forming apparatus 102. When the login session information is not included in the requested URL or the login session information included in the requested URL does not match the session ID stored in the image forming apparatus 102, Web page data of a login screen is transmitted to the client to cause a user to perform a login operation.

On the other hand, when the login session information included in the requested URL matches the session ID stored in the image forming apparatus 102, the same user as the user who logs in the image forming apparatus 102 performs login processing with the remote UI function. The application 310 is controlled in response to the HTTP request, and Web page data is transmitted as an HTTP response.

In the above process of the flowchart, when the connection from the VNC client 520 is established during the login of a user in the image forming apparatus 102, a URL including an ID identifying a login session is transmitted to the VNC client 520. When the transmitted URL is accessed, the remote UI function can be used in the login state of the same user as the user who is logging in. Accordingly, there is no need to perform a login operation again, and this leads to convenience.

The control performed when an image processing apparatus is remotely operated has been described, but embodiments of the present disclosure are applicable to control performed when other apparatuses such as a network camera and various network home appliances are remotely operated.

In the first and second embodiments, the VNC client 520 may be implemented as a Web application operating on the Web browser 530. In this case, when the URL information display region 702 is clicked, the Web browser 530 may open another tab or another window different from the tab or the window that displays the VNC client 520 to display a remote UI. When the URL information display region 702 is clicked, a remote UI does not necessarily have to be displayed. When URL information is received, the received URL may be automatically accessed to display a remote UI. A link to the remote operation function may be placed on, for example, a top page of a remote UI to enable the transition from the remote UI function to the remote operation function.

The image forming apparatus 102 according to each of the embodiments includes the VNC server 320 configured to provide a function of providing screen information of an operation screen displayed on an operation unit of the image forming apparatus 102 for the PC 101 that is an external apparatus connected to the image forming apparatus 102 via a network and receiving from, the PC 101 that displays a screen corresponding to the operation screen based on the screen information, operation information corresponding to an operation performed on the screen. The image forming apparatus 102 includes the Web server 330 capable of providing a function of operating the image forming apparatus 102 from the PC 101. The VNC server 320 is further configured to provide for the PC 101 identification information (URL) used for calling up, from the Web server 330, a function of performing an alternative operation of an operation available on an operation screen based on screen information that the VNC server 320 is providing.

On the other hand, the PC 101 includes the VNC client 520 configured to display an operation screen based on the screen information provided by the VNC server 320 and transmit, in response to an operation performed on the operation screen, an operation request based on the operation to the VNC server 320. The PC 101 includes the Web browser 530 configured to call up (make an HTTP request for) a function of the Web server 330. The VNC client 520 is further configured to display identification information (URL) received from the VNC server 320 and notify the Web browser 530 of the identification information in response to an instruction for the identification information. The Web browser 530 is further configured to make an HTTP request for (call up a function of) the Web server 330 with the identification information in response to the notification of the identification information.

With the above configuration, a user who is using the remote operation function can be appropriately directed from an external apparatus to another remote operation function (the remote UI function in the present embodiments) with which an operation equivalent to an operation performed on a screen displayed with the remote operation function can be performed. This can improve the convenience of users.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-142393 filed Sep. 1, 2023, which is hereby incorporated by reference herein in its entirety.

What is claimed is:

1. An image processing apparatus comprising:
at least one memory storing executable instructions; and
at least one processor that is configured, upon execution of the stored instructions, to operate as
a first server configured to
provide a screen information corresponding to an operation screen displayed on an operation unit of the image processing apparatus to an external apparatus connected to the image processing apparatus via a network and
receive from, the external apparatus that uses the screen information and is displaying a screen corresponding to the operation screen, operation information corresponding to an operation performed on the screen; and
a second server that is configured to provide a function of operating the image processing apparatus from the external apparatus and is different from the first server,
wherein the first server provides identification information to the external apparatus which is used for calling up, from the second server, a function that performs an alternative operation which corresponds to an operation available on the operation screen provided by the first server to the external apparatus.

2. The image processing apparatus according to claim 1,
wherein the first server is a VNC server,
wherein the second server is a Web server, and
wherein the identification information is a URL for causing the Web server to perform processing that performs the alternative operation.

3. The image processing apparatus according to claim 1, wherein execution of the stored instructions further configures the at least one processor to:
perform user authentication; and
manage a login session of an authorized user,
wherein the first server adds information that identifies a managed login session to the identification information.

4. A system comprising:
an image processing apparatus; and
an external apparatus, wherein the image processing apparatus and the external apparatus communicate with each other,
the image processing apparatus including,
at least one memory storing executable instructions; and
at least one processor that is configured, upon execution of the stored instructions, to operate as
a first server configured to
provide a screen information corresponding to an operation screen displayed on an operation unit of the image processing apparatus to an external apparatus connected to the image processing apparatus via a network and
receive from, the external apparatus that uses the screen information and is displaying a screen corresponding to the operation screen, operation information corresponding to an operation performed on the screen; and
a second server that is configured to provide a function of operating the image processing apparatus from the external apparatus and is different from the first server,
wherein the first server provides identification information to the external apparatus which is used for calling up, from the second server, a function that performs an alternative operation which corresponds to an operation available on the operation screen provided by the first server to the external apparatus,
the external apparatus including,
at least one memory storing executable instructions; and
at least one processor that is configured, upon execution of the stored instructions, to operate as
a first control unit configured to display an operation screen based on the screen information provided by the first server and transmit, in response to an operation performed on the operation screen, an operation request based on the operation to the first server,
a second control unit configured to call up a function of the second server to enable an operation of the image processing apparatus,
the first control unit being further configured to notify the second control unit of identification information received from the first server,
the second control unit being further configured to call up a function of the second server with the notified identification information.

5. The system according to claim 4, wherein the first control unit displays identification information received from the first server and notifies the second control unit of the identification information in response to a user instruction for the identification information.

6. The system according to claim 4,
wherein the first server is a VNC server,
wherein the second server is a Web server,
wherein the identification information is a URL for causing the Web server to perform processing that performs the alternative operation,
wherein the first control unit is a VNC client, and
wherein the second server is a Web browser.

7. The system according to claim 6, wherein the first control unit is provided by an application executed on the Web browser.

8. The system according to any one of claims 4,
wherein execution of the stored instructions further configures the image processing apparatus to operate as an authentication unit configured to perform user authentication and a management unit configured to manage a login session of a user authorized by the authentication unit, and
wherein the first server adds information for identifying a login session managed by the management unit to the identification information.

9. A control method for an image processing apparatus, comprising:
a first providing step of causing a first providing unit to provide a function of providing screen information of an operation screen displayed on an operation unit of the image processing apparatus for an external apparatus connected to the image processing apparatus via a network and receiving from, the external apparatus that displays a screen corresponding to the operation screen based on the screen information, operation information corresponding to an operation performed on the screen; and
a second providing step of causing a second providing unit different from the first providing unit to provide a function of operating the image processing apparatus from the external apparatus,
wherein, in the first providing step, there is further provided, for the external apparatus, identification information used for calling up, from the second providing unit, a function of performing an alternative operation of an operation available on an operation screen based on screen information that the first providing unit is providing.

10. A non-transitory storage medium storing a program that, when executed by one or more processors of an image processing apparatus, causes the image processing apparatus to execute a control method, the control method comprising:
causing a computer to function as a first providing unit configured to provide a function of providing screen information of an operation screen displayed on an operation unit of an image processing apparatus for an external apparatus connected to the image processing apparatus via a network and receiving from, the external apparatus that displays a screen corresponding to the operation screen based on the screen information, operation information corresponding to an operation performed on the screen.
